(19) United States
(12) Patent Application Publication
(10) Pub. No.: US 2020/0175621 A1
(43) Pub. Date: Jun. 4, 2020

(54) AUTOMATED ADDRESS RESOLUTION FOR DOCUMENT MANAGEMENT AND PRODUCTION

(71) Applicant: JetClosing Inc., Seattle, WA (US)

(72) Inventors: David Wolf, Redwood, WA (US); Arthur C. Delight, IV, Seattle, WA (US)

(21) Appl. No.: 16/694,074

(22) Filed: Nov. 25, 2019

Related U.S. Application Data
(60) Provisional application No. 62/773,956, filed on Nov. 30, 2018.

(51) Int. Cl. G06Q 50/16; G06F 16/25

(52) U.S. Cl. CPC G06Q 50/16; G06F 16/252

(57) ABSTRACT

Disclosed herein are methods, devices, and systems for facilitating data transactions, such as real estate transactions. Some embodiments disclose methods for determining a legal address recognized for a real property based on a received mailing address for the real property. The methods can include accessing, such as from a client device, a legal address record or database. The method can acquire further information regarding the data or real estate transaction while concurrently accessing the legal address record. In the case that an unambiguous match between the mailing address and the legal address record is not found, the method can interactively use the client device to determine the recognized legal address based on ownership data. Some embodiments disclose electronic devices that can implement such methods.

### CROSS REFERENCE TO RELATED APPLICATION(S)

This application is a nonprovisional of and claims the benefit under 35 U.S.C. 119(e) of U.S. Provisional Patent Application No. 62/773,956, filed Nov. 30, 2018, entitled “Automated Address Resolution for Document Management and Production,” the contents of which are incorporated by reference as if fully disclosed herein.

### FIELD

The present disclosure generally relates to devices, methods, and systems that may be used in facilitating real estate transactions. Various embodiments are directed to efficiently obtaining information for such transactions and resolving discrepancies in information, such as a mailing address, a legal address, or a legal description of a real property, provided as part of a real estate transaction.

### BACKGROUND

Many computing systems or other electronic devices run operations or programs that manage and produce transaction documents or data using inputs received from one or more client devices of users, and provide output or responses to the users' client devices. Multiple such operations can occur in sequence or in parallel, with the output or response at each stage of the sequence depending on the previous input or inputs from the user.

Such programs may operate concurrently over multiple distributed devices, in which the one or more users' client devices may be communicatively linked with a separately located host device, such as servers or cloud computing centers. The host device may itself operate to access various databases as part of the operations or programs.

In such systems for use by a consumer, reducing idle times between displays of outputs or subsequent data entry screens after a user has entered information can improve the consumer's experience in using such systems and devices. The systems, devices, and methods disclosed herein are generally directed to minimizing such idle times. Also, it is desirable for such systems to be able to provide interactive assistance to users to obtain accurate information.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

In one example, disclosed herein is an electronic device including a processing unit, a user interface, and a memory that stores instructions that can be executed by the processing unit. The instructions can cause the processing unit to receive, from a user interface of a client device, a mailing address associated with a real property. The processing unit may then access a legal address database. The processing unit can concurrently compare the received mailing address with the legal address database and cause the user interface to request further information related to the real estate transaction. In the case that the legal address database contains a legal address recognized as corresponding to the real property associated with the mailing address, the legal address corresponding to the real property can be obtained from the legal address database. The obtained legal address may then be used in documents related to the real estate transaction.

As another example, described herein is a method including an operation of receiving, from a user interface, a mailing address associated with a real property, or other information related to a real estate transaction. The method further includes an operation of comparing the received mailing address or other information with a legal address record, while concurrently causing the user interface to request further information related to the real property or a real estate transaction regarding the real property. The method further includes an operation of obtaining a legal address recognized as corresponding to the real property from the legal address record. The method may be implemented on a client device used by an agent or a party to the real estate transaction. The user interface may be a user interface displayed on a screen of the client device, and the mailing address may be received using the user interface.

In related embodiments, such methods can include validating the received mailing address or the other received information. In the case that the received mailing address is determined to be invalid, the methods may include causing the user interface to indicate that the received mailing address is invalid and presenting a request for reentry of an updated mailing address. The methods may also cause the user interface to implement autofill suggestions for the mailing address.

In the case that the legal address record has no legal address recognized as corresponding to the real property associated with the received mailing address, or if other discrepancies or problems are detected in the received mailing address, the devices and methods can include operations for resolving the discrepancies. For example, the operations can include causing the user interface to indicate that there is no legal address recognized as corresponding to the real property associated with the received mailing address, and requesting responses from the user of the client device. The devices and methods may also include operations for determining a list of likely legal addresses that could be the correct legal address for the received mailing address. Further operations may then cause the user interface to present the list of one or more likely legal addresses, in combination with respective ownership data or other information, so that the user can select the correct legal address. In these examples, the legal addresses can be determined to have a likelihood of corresponding to the real property and associated with the received mailing address.

### BRIEF DESCRIPTION OF THE DRAWINGS

The disclosure will be readily understood by the following detailed description in conjunction with the accompanying drawings, wherein like reference numerals designate like structural elements.

FIG. 1A is a block diagram of high level components of a system for real estate transactions operating between multiple devices, such as described herein.

FIG. 1B illustrates details of the components of the system shown in FIG. 1A, according to an embodiment.

FIG. 1C illustrates user interfaces of the client devices shown in FIG. 1B, according to an embodiment.

FIG. 1D illustrates an example condominium complex located on intersecting streets.

FIG. 1E depicts another simplified signal flow diagram of an event-driven system including a host service and a client application, such as described herein.

FIG. 2 is a flow chart depicting example operations of a method of obtaining or verifying a legal address of real property, and managing documentation thereof, according to an embodiment.

FIG. 3 is a flow chart depicting example operations of a method of verifying a received mailing address, according to an embodiment.

FIG. 4A is a flow chart depicting example operations of a method of obtaining a legal address corresponding to a received mailing address, according to an embodiment.

FIG. 4B is a flow chart of a method for resolving a legal address based on a received mailing address, according to an embodiment.

FIG. 4C illustrates a graphical user interface, according to an embodiment.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The embodiments described herein are directed to devices, systems, and methods involving user interfaces to collect and/or verify information in real estate transactions, such as buying or selling of a real property, closing escrow or title, and the like. As a motivating example, a host service computer system, which may be cloud based, may interact with client devices of parties or agents to the real estate transaction to obtain information related to the real estate transaction. The users of the client devices may then enter information. The embodiments may also proceed over multiple stages, during each of which respective information may be entered and verified. These stages may operate in parallel to improve user experience. At each stage, there may be possible multiple data entry screens, with a selection determined by the previously entered information.

For simplicity of description, the embodiments that follow reference an example in which information or data is collected from a client device operating a user interface and input provided by a user in the course of initiating, advancing, and/or closing a real estate transaction. Examples of real estate transactions, such as described herein, include but are not limited to buying or selling a house, a condominium, a lot, or commercial property. Still further examples of real estate transactions include transferring ownership, obtaining building or renovation permits, real estate actions related to escrow and title, among other real estate transactions.

A user of a user interface, such as described herein, may be a seller, a buyer, a real estate agent, an escrow agent, or another party to a real estate transaction. In many cases, a real estate agent, a banker, an attorney, or another representative may provide assistance to, or work in conjunction with, a buyer, a seller, a developer or another party to the real estate transaction. Hereinafter, the term “agent” is used to refer to any such representative providing assistance, and the term “party” will refer to the person or persons receiving such assistance. Example assistance can include obtaining information for completing one or more documents, whether printed or electronic, needed to close or advance a particular real estate transaction. It should be noted that during progression of the real estate transaction, a particular user's role may change from party to agent.

An example of such information includes, but is not limited to, obtaining a mailing address and/or a corresponding recognized legal address for a particular real property that is the subject of a particular real estate transaction. As used herein, a “mailing address” for a real property is an address that is accepted by a postal or courier service for delivering mail to the real property, or may be an address recognized or accepted by a local government as a locator for the real property, but not recognized for real estate transactions. As used herein, the term “recognized legal address” or, simply, “legal address” refers to a property descriptor used by a government authority to define the metes and bounds of a real property, which may be legally required to initiate or advance a transaction involving the real property. One example of a legal address may be a Parcel Identifier recognized by a local taxing authority.

A user interface may be implemented as a graphical user interface (GUI). Hereinafter, for simplicity of explanation, the term “graphical user interface” will encompass any user interface, whether graphical, physical, or otherwise. A GUI, such as described herein, can include one or more fields to collect information related to a real estate transaction. In some cases, certain information (such as a mailing address, a legal address, or a legal description) may be located—in whole or in part—in one or more databases, records, or electronic libraries maintained by a third party or by various local or national government entities. As may be appreciated, responses to queries of such databases may take substantial time to complete. Furthermore, third party or government databases may not, in all circumstances, respond to a query with accurate or complete data.

For example, in certain situations, a mailing address and a legal address may differ for a particular real property. An actual instance of this occurs with the New York Stock Exchange that has a mailing street address of 11 Wall Street, but a legal street address of 2 Broad Street. Continuing the example, a multi-unit housing complex, having a single mailing address separated by unit number, may include units with legal addresses associated with different streets. In these examples, a third party database may return a mailing address in response to a query for a legal address or vice versa. In these examples, further queries to further databases may be required to verify data received from the third party database. In such examples, conventional interfaces display a progress bar, a spinner, or other progress indicator while one or more queries submitted to one or more third party databases are pending, preventing or otherwise delaying further data input by a user of the conventional user interface.

Accordingly, some embodiments disclosed herein are directed to overcoming problems arising either from lag time needed to obtain a legal address (or other information), or from resolving data or information mismatches (such as between, in one example, a mailing address and a legal address for a real property). Some embodiments are directed to systems and methods (as may be implemented as a program or application running on a computing device) for receiving a mailing address, and concurrently or simultaneously resolving a legal address for that mailing address while proceeding with further stages of a real estate transaction.

Some embodiments also may operate interactively on and/or through a device, such as a smartphone, a laptop or tablet computer, a desktop computer and the like (referred to herein as a “client device”), that may be used by an agent or a party to a real estate transaction to resolve situations in which multiple legal addresses are found that may correspond to a given mailing address. In some embodiments, in such cases the multiple possible legal addresses may be displayed on a GUI of the client device. Such embodiments may also display an owner of record, other ownership data, or other descriptive information, for each of the multiple possible legal addresses. Examples of such other descriptive information include, but are not limited to, maps or satellite images. The client device may then display a GUI by which the agent or party can select the correct legal address.

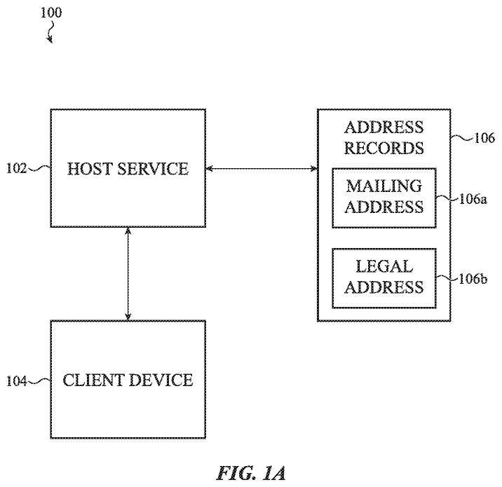

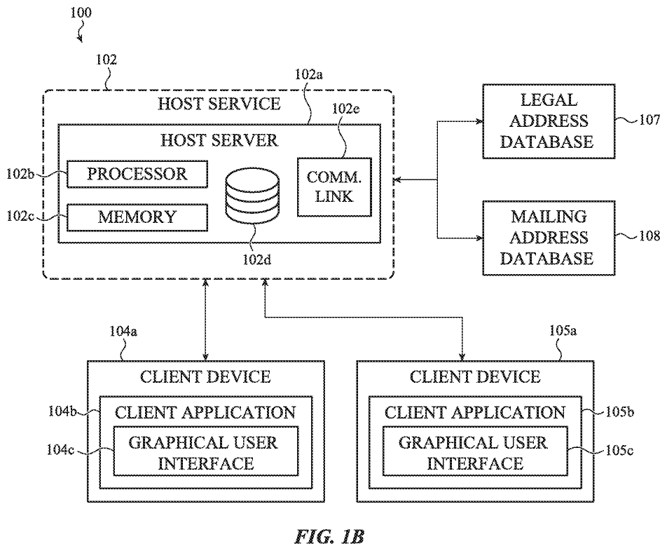

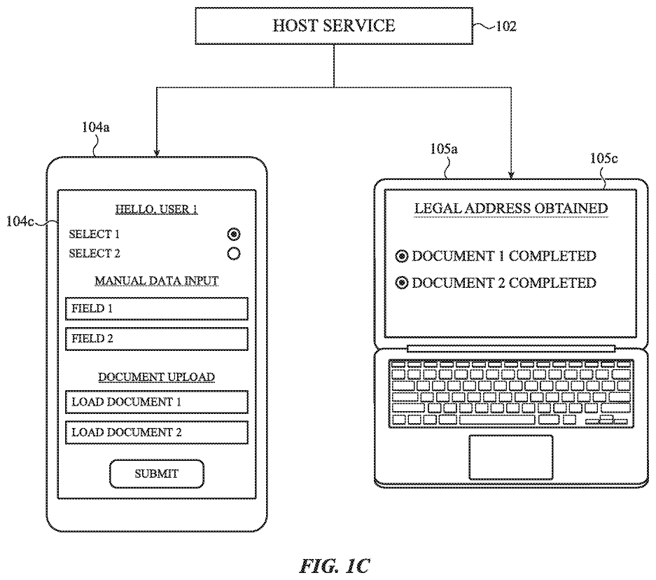

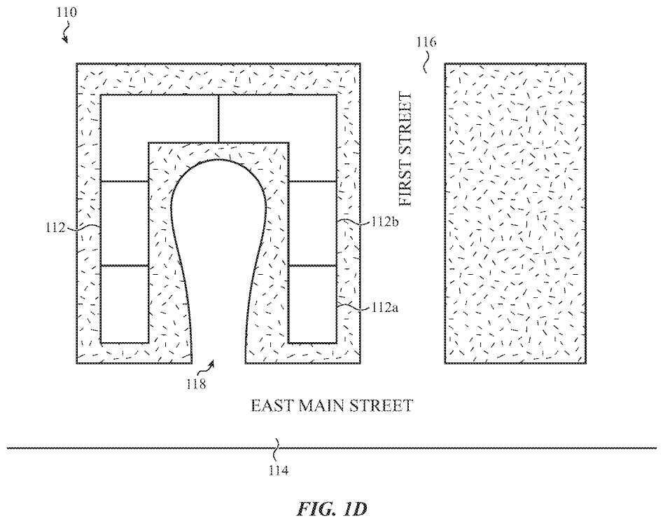

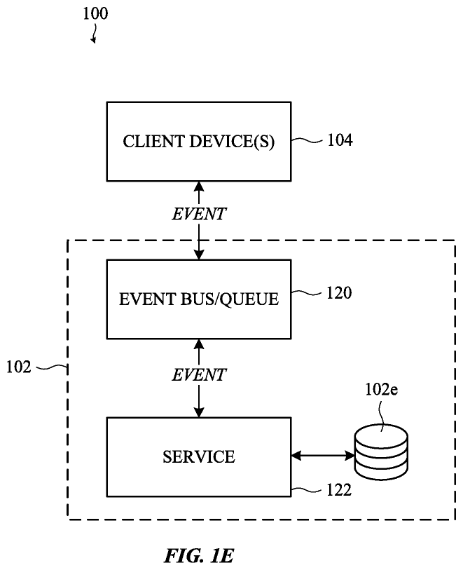

These and other embodiments are discussed below with reference to FIGS. 1A-4C. However, those skilled in the art will readily appreciate that the detailed description given herein with respect to these Figures is for explanatory purposes only and should not be construed as limiting.

FIG. 1A shows a high level configuration 100 of components, systems, and services that may use various embodiments disclosed herein during a data transaction, such as a real estate transaction. The configuration 100 includes a client device 104 operable to communicably couple or otherwise link with a host service 102. The client device 104 may be a laptop or tablet computer, a desktop computer, a smart phone, or another electronic device. The client device 104 may be operable to run programs and/or applications by which an agent or party can complete or fill in information in documents for the real estate transaction, and transmit that information to the host service 102. The client device 104 may also receive and display information and/or documents from the host service 102 related to the real estate transaction. The display may be on a GUI operated by the client device 104. In some embodiments, the client device 104 is a smart phone, with the program implemented as an app running thereon.

The client device 104 may comprise one or more processing units; examples of such include a central processing unit, a processor, a microcontroller, a field programmable gate array, or other electronic components configured to receive and process data. The client device 104 may include one or more memory components (hereinafter, “memory”). The memory may include a non-volatile or non-transitory memory or a volatile memory. The memory may store one or more programs or applications (hereinafter, “program”) that can be executed by the processing unit. The client device 104 may also contain a GUI through which data or information can be entered into the client device 104 and used by a program to determine outputs or results to return. The results of the program may be returned as a display on the GUI.

The client device 104 can be operable to connect or link to a host service 102, such as by either a wired or wireless internet connection, intranet connection, local area network, or other link. The host service 102 can be a remote server or computer system maintained by a third party and accessible through, or as part of, a cloud-based system. The host service 102 and the programs running on it may be implemented as a cloud computing service. The host service 102 may maintain or have access to various databases and records related to multiple real estate locations, such as addresses, legal address records, ownership, lien and/or escrow status, geographic information related to lots, or other such information.

One type of database that may be accessed by the host service 102 is a database or library of address records 106. Some or all of the address records 106 may be maintained and/or owned by the host service 102. Additionally and/or alternatively, some or all may be maintained by a different service or organization, such as a city, county, or other government agency. In the latter case, the host service 102 may be configured for efficient accessing and retrieving of information from the address records 106, and to supply the information to the client device 104.

Address records 106 may include at least two types of addresses: mailing addresses 106a and/or legal addresses 106b. The legal addresses 106b may be maintained in a legal address record or database by a government authority with jurisdiction regarding real estate transactions for the real property. As previously discussed, the mailing address and the legal address may sometimes differ for a particular real property. In some situations, a first company or organization may have or maintain one type of address, and a second organization may maintain another type. For example, the mailing addresses may be maintained in a database or library of a mapping or courier company, and the legal addresses may be maintained in a legal address record or database maintained by a county government. The host service 102 may have access to both such databases.

While proceeding with a real estate transaction, an agent or party using the client device 104 may need to either enter or obtain information about the real property, in particular, its legal address. Such information may be needed, for example, to complete various documents related to the real estate transaction. To this end, a program, application, app, or application program interface (API) running on the client device 104 may transmit a request for or with the information to the host service 102. The host service 102 may then access and/or search the address records 106 to obtain the requested information, and then transmit that information back to the client device 104. The host service 102 may store a local database or record of searches it has performed. This can improve the efficiency of performing the real estate transaction, as it may be that completing the real estate transaction may occur over an extended period of time (e.g., days, weeks) as the agents and parties negotiate and obtain needed information.

FIG. 1B shows more details and alternatives of the configuration 100 shown in FIG. 1A. Some or all of the details may be included in the disclosed embodiments. In the configuration 100 shown, the host service 102 may include one or more servers, such as server 102a. The server 102a may in turn include one or more processors 102b, memory 102c, a storage array or database 102d, and a communication/networking link 102e. The one or more processors 102b may include microprocessors, arithmetic logic units, graphics processing units, field programmable gate arrays, and the like. The memory 102c may be implemented in random access memory, cache, read only memory, and the like. The storage array 102d may be implemented as disk or other non-volatile memory. The communication link 102e may be implemented by either or both of wired or wireless technologies, such as Ethernet or WiFi, or other communication technologies.

The host service 102 may be cloud based and use the communication link 102e to access either or both of separated address databases or records: the legal address database 107 and the mailing address database 108. In the configuration of FIG. 1B, these two address databases may be maintained by separate entities in separate locations. For example, the mailing address database 108 may be maintained by the United States Postal Service or a commercial shipping company, whereas the legal address database may be maintained by a county government records agency.

In the configuration of FIG. 1B, the communication link 102e may also interact (e.g., send and receive content) with more than one client device. In the configuration of FIG. 1B, there are two such client devices, client device A 104a and client device B 105a, though in other configurations there may be more than two client devices. The communication link 102e may be configured to interact simultaneously with client device A 104a and client device B 105a.

Such simultaneity of interaction can allow, for example, a seller using client device A 104a to be in a first location, an agent using client device B 105a to be at a second location, and the host service 102 to be at a third location. This can improve the user experience and efficiency of completing the real estate transaction.

The client device A 104a may include a client application 104b running on an internal processor, such as the processor 102b described above. The client application 104b may operate to display a GUI 104c through which a user of client device A 104a may enter data or information needed for a real estate transaction, and receive or download completed documents based on the entered data. The GUI 104c may also display warning messages and dialog boxes related to incorrect or ambiguous information entered by the user.

FIG. 1C shows a configuration of the host service 102 in communication, such as by the communication link 102e of the host server 102a, with specific examples of client device A 104a and client device B 105a. The host service 102 may be implemented as a cloud based computing service.

In the configuration shown in FIG. 1C, client device A 104a is a smart phone running an app (such as may be downloaded from the host service 102) that displays the GUI 104c. The client device B 105a is a laptop computer running software, that also may have been downloaded from the host service 102, that displays the GUI 105c. Either or both of the GUIs 104c and 105c may have fields by which a user may enter data for information. Hereinafter, reference and discussions related to client device A 104a will be applicable alternatively and/or additionally to client device B 105a also.

The app and/or software downloaded from host service 102 may be specific to the user's situation in a real estate transaction. For example, the host service may provide one version of software for use by a client device of a seller or buyer, and another version of the software for use by a client device of an agent or attorney. Further, the versions of the software may be optimized for the chosen hardware of the client device (e.g., the model, version, or operating system of the client device).

FIG. 1D shows an example aerial representation 110 of a real property 112 located at a corner of a first street 116 (labeled with the sample name “First Street”) and a second street 114 (labeled with the sample name “East Main Street”). In the representation 110, the real property 112 is a condominium complex, having particular condominium units 112a and 112b. The condominium complex includes a cul-de-sac 118 having an entryway that joins with the second street 114.

FIG. 1D illustrates one situation of how discrepancies in information entered by a party or agent may arise. It may be that the legal address for the condominium unit 112b is (as an example) 112b East Main Street. However, as an example, the condominium unit 112a may be a front office for the condominium complex 112, which may receive packages addressed to either 112b East Main Street, or addressed to 112b First Street. Another situation for how discrepancies may arise is if the condominium complex 112 were instead a single but subdivided lot owned by a single person, for which there was a common driveway.

As an illustration of one of the methods that may be performed by the embodiments disclosed herein, the particular condominium unit 112b may be offered for sale. An agent or party may use the client device 104 to advance the real estate transaction. To do so, it may be necessary to obtain the legal address of the condominium unit 112b to prepare documents for the real estate transaction. The buyer or agent may have been sending mail to, and receiving replies from, the seller using the mailing address 112b First Street. However, the government records for that particular condominium unit recognize its legal address as 112b East Main Street, since the cul-de-sac 118 is considered to be part of East Main Street.

Referring back to FIG. 1B, the mailing address may be entered into a field of GUI 104c of the client device 104a. The mailing address may be transmitted to a host service 102. The host service 102 may be one or more servers or computers operated by a commercial vendor of geographic, mapping, and real estate information and data, or by a company performing real estate transactions, or by a government electronic library, record, or database, or by some other organization. The transmission may include a query to determine a unique and complete legal address recognized by the government as corresponding to the condominium 112b. The host service 102 may access the legal address database 107 to obtain the legal address or legal description recognized for the condominium 112b and return that information to the client device 104a.

It may be appreciated that a system, such as described herein, can be implemented with any number of suitable communications architectures. For example, although many embodiments described herein reference a request-response architecture, it may be appreciated that this is merely one example. More specifically, in other embodiments, such as shown in FIG. 1E, an event-driven architecture can be used. In particular the system 100 depicted in FIG. 1E shows a host service 102 communicably coupled to a client device 104. The host server 103 includes an event bus 120 (also referred to as an event dispatch, an event queue, a message queue, or any other suitable similar phrase). The event bus 120 is configured to asynchronously receive and store discrete data items referred to as “events” formatted according to a specification or protocol unique to the system 100 and/or conforming with a specified messaging protocol. In this example, the event bus 120 can receive events from the client device 104 and store those events in a queue based on a time stamp or indexed order in which each event was received and/or added to the event bus 120. Thereafter, events stored by the event bus 120 can be consumed by one or more services, servers, microservices, functions, lambda functions, and so on associated with an operation or task of the host service 104. Collectively, these example event-consuming elements are depicted in FIG. 1E as the service 122. The service 122 can receive and/or consume events and/or be notified of new events from the event bus 120 in any suitable manner. Examples include, but are not limited to: registering the service 122 as a callback executed by the event bus 120 once an event of a given type is received; registering the service 122 as a subscriber of a particular message type generated by the event bus 120 in response to the event bus 120 receiving an event of a particular type or an event that changes a particular state; registering the event bus 120 as a subscriber of one or more announcements of state changes or events periodically generated or broadcast by the event bus 120; and so on. In some embodiments, the service 114 can include or can be coupled to a state database 102e that locally stores partial or complete state information or event information, at least partially mirroring information contained/stored by the event bus 120.

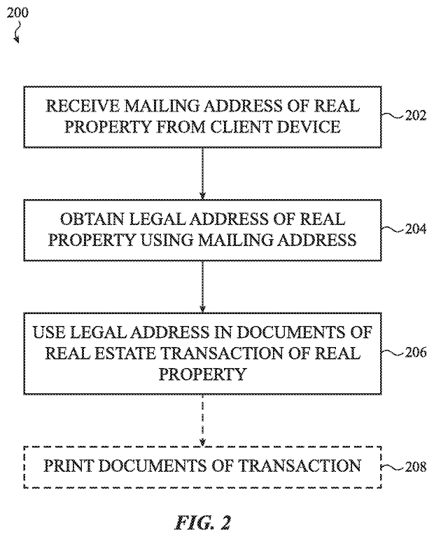

FIG. 2 shows a flow chart of method 200 of obtaining a legal address recognized for a real property involved in a real estate transaction. The method may be used as part of a program or application running on the host service 102 that is communicatively linked with client devices 104a or 105a across a local network, in a cloud-based network or system, and otherwise as described above in relation to FIGS. 1A-1B.

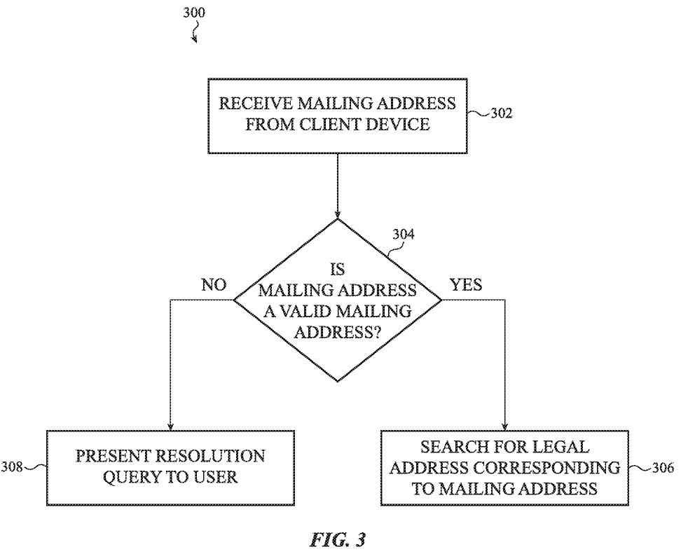

At stage 202, the method receives a mailing address, such as may be entered through the GUI 104c and transmitted by the client device A 104a to the host service 102. The method may operate to check for validity of the received mailing address, as explained in more detail below in relation to FIG. 3. This check may be performed by the host service 102 accessing the mailing address database 108 and searching for the received mailing address. In the case that the mailing address is not found in mailing address database 108, the host service 102 may transmit to the client device A 104a a message to display a warning message and/or a dialog box on the GUI 104c.

At stage 204, the method uses the received mailing address to obtain, or attempt to obtain, an address that is recognized, such as by a relevant government authority, as the legal address for the real property located at the mailing address. Stage 204 may be attempted even if validation of the mailing address is not performed, or if the received mailing address is not recognized as valid.

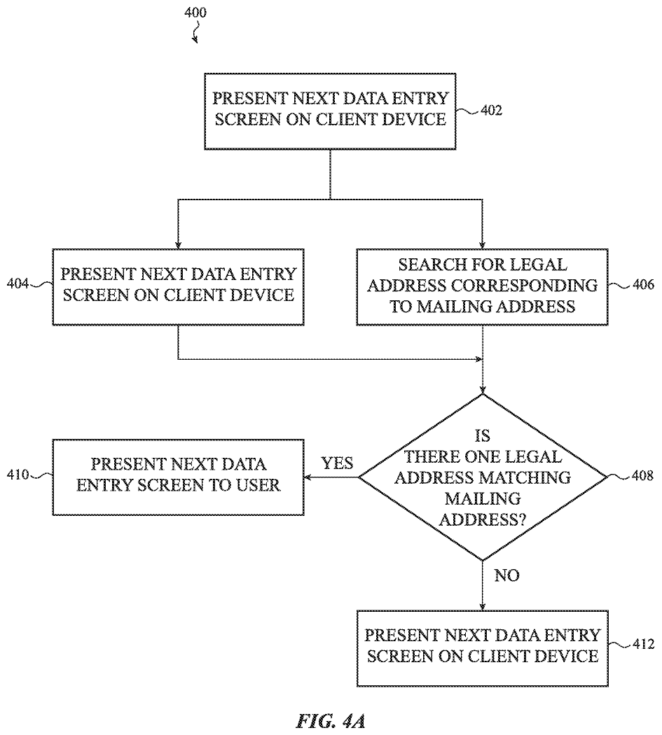

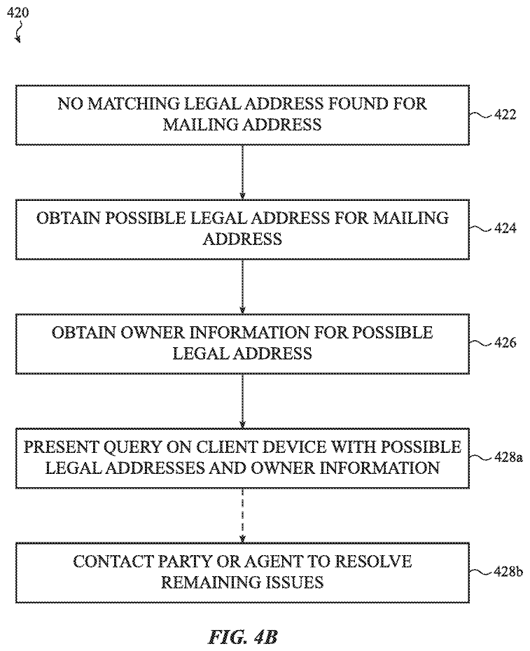

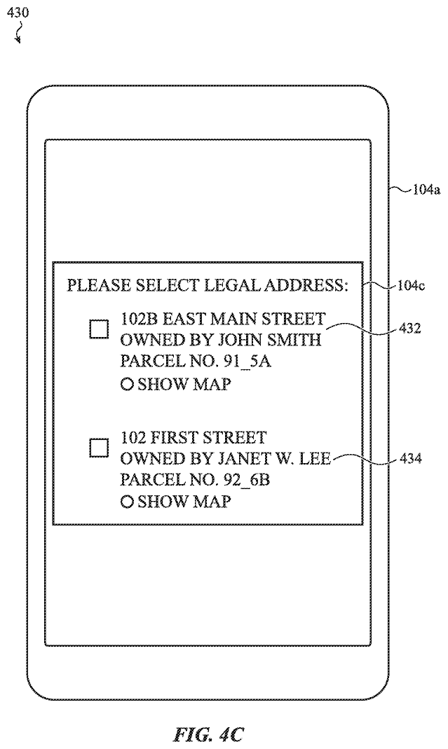

At stage 204, the method can obtain the legal address corresponding to the mailing address either by directly accessing an electronic library or database of addresses, such as the legal address database 107. The legal address database 107 may be maintained by the host service 102, or may be maintained by a responsible government authority. In an ideal case, a unique and recognized legal address is found for the real property corresponding to the received mailing address. However, there are potential problems that can arise, as will be discussed below in relation to FIGS. 3 and 4A.

Even in the absence of problems in determining the legal address, accessing the needed databases may take time. As an example, users (such as the agent or party) may find a wait time of multiple seconds while using a computer program to be frustrating and undesirable. Various embodiments can improve user experience by concurrently proceeding to gather further information, or performing other actions related to the real estate transaction, from the agent or party while continuing with the process of obtaining the legal address. For example, at stage 204 the client device A 104a can display a subsequent data entry dialog box on GUI 104c to the agent or party while the legal address is being obtained.

At stage 206, having obtained the legal address corresponding to the received mailing address, the legal address can then be used to prepare various documents used or useful to advance the real estate transaction. Such documents may include, but are not limited to, escrow, title and loan documents. The method may automatically substitute the legal address for the received mailing address throughout the various documents, and may recognize the mailing address as an alias for the legal address whenever the mailing address is subsequently received in the course of completing the real estate transaction. Optionally, the method may have the client device A 104a display a dialog box on the GUI 104c requesting user agreement to such substitutions.

At the optional stage 208 of the method 200, the documents that have been completed using the obtained legal address may then be printed, either by the host service 102, or by being downloaded to either or both of client device A 104a and client device B 105a, and printed therefrom. In additional and/or alternative embodiments, the host service 102 may send a verification/authentication request as part of completing the documents. This may be a requirement to a user of a client device to enter an e-signature, enter a password, perform a biometric authorization, or another method. The host service 102 may also generate an executable document.

In some circumstances, however, there may be issues in obtaining the legal address based on just a provided mailing address. One such issue may be that the mailing address provided to the host service 102 is not recognized even as a valid mailing address. Another could be that the mailing address provided is recognized as a valid mailing address associated with the real property, but no corresponding legal address is found that unambiguously or uniquely is recognized for the real property at that mailing address. The embodiments may include operations and steps to overcome such issues to obtain the recognized legal address for the real property. Such operations and steps will now be explained.

FIG. 3 is a flow chart of a method 300 that uses a mailing address received from a user interface of client device A 104a (such as may be entered by an agent or party to a real estate transaction). The stages of the method 300 may be used as part of the method 200 described above.

At stage 302, a mailing address for a real property is received at host service 102. For example, an agent or party may enter the mailing address into GUI 104c provided on the client device A 104A. The client device A 104a may then transmit or otherwise provide the mailing address to the host service 102.

At stage 304, the mailing address may be checked against a mailing address database to determine its validity as a mailing address. To have a greater likelihood that the mailing address is a valid mailing address, either or both of host service 102 and client device A 104a may include at least a partial database of mailing addresses, which may be for just the local area (e.g., city, county) of the real property, or for a larger surrounding region. By storing or accessing such a focused mailing address database, invalid (e.g., misspelled) mailing addresses may be more quickly recognized as such. A warning and resolution GUI may then be provided on the client device for the party or agent to resolve the discrepancy; the method 300 may further provide a list of possible mailing addresses, map data or links to maps, legal descriptions, and the like to aid the party or agent in providing the intended mailing address. Alternatively, the host service 102 may open a link to a third party mailing address database to search further for an unrecognized mailing address. In yet another alternative, the host service 102 may provide the client device with access to the third party mailing address database.

In any of these cases, while the user of the client device is entering the mailing address, the client device A 104a may present a list of suggested completions for the mailing address. The list may be presented in a pop-up GUI with the suggested completions presented for autofill.

There are two possibilities for the received mailing address: either the method has determined that it is a valid mailing address, or it is not found to be a valid mailing address. In the former case, the method may also display a confirmation dialog box through the GUI 104c to obtain confirmation from the user that the received and validated mailing address is indeed the mailing address intended by the user. Also in the former case, at stage 306, the method 300 uses the mailing address in further operations to search for a legal address recognized for the real property associated to the mailing address. Such further operations will be explained in more detail below in relation to FIG. 4A.

In the case that the entered mailing address is not determined to be a valid mailing address, at stage 308 a query may be presented to the user, such as in a warning or error message presented on GUI 104c of the client device A 104a. The query may include fields or a dialog box asking for reentry of the mailing address, and may also include a list of known mailing addresses that are close to the entered mailing address. As an example, if the entered mailing address was 112b Main Street, and the mailing address database contains 112b East Main Street, that complete and known mailing address may be presented as a suggestion for the user. As another example, the mailing address may have been incorrectly entered as 111b East Main Street, which is not included in the mailing address database 108. The method may use a least difference algorithm and present 112b East Main Street for the user.

As part of determining whether a received mailing address is valid, the host service 102 may access multiple address databases, which may be operated and/or maintained by different commercial providers or government entities. For example, one mailing address database may contain only mailing addresses for residential properties, and a second database may contain only mailing addresses of commercial entities. The host service may have knowledge (e.g., from information previously entered by either a party or agent involved in the real estate transaction) of which database to search first. If the real estate transaction is known to be for a residence but the received mailing address is found in the commercial entity mailing address database, the method 300 may cause the GUI 104c to display a warning message and/or request clarification.

In another example, there may be multiple databases for mailing addresses for residential real estate, successively increasing in size to cover greater geographical areas. The method 300 may begin searching from the smallest database to the largest. Alternatively, other, higher level, information (e.g., zip code or city) received from a user may be used by the method 300 to select the first database in which to search.

In a third example, if a part of a received mailing address (e.g., a street name and number) are found but conflict with the city or zip code, as may happen for properties near city or zip code boundaries, the method 300 may also display a warning message and/or request clarification.

Additionally and/or alternatively, at stage 308 the query may ask if the user would nevertheless proceed with determining a legal address corresponding to the entered mailing address. As explained below, further embodiments may be able to determine likely or possible legal addresses corresponding to an entered mailing address by comparing the entered mailing address to the library or database of legal addresses 107.

FIGS. 4A-B show flow charts of methods 400 and 420 that may be included as part of the method 200 depicted in FIG. 2, or as standalone methods.

FIG. 4A shows a flow chart of a method 400 of resolving a legal address corresponding to a mailing address associated with a real property. The method 400 may be implemented by the host service 102 that is communicatively linked with the one or more client devices, such as client device A 104a and client device B 105a.

At stage 402, a user interface, such as GUI 104c of the client device A 104a, is presented to a user, such as an agent or party to a real estate transaction. The user of the client device A 104a can enter a mailing address believed to be associated with the real property. The mailing address is then received by the program or process. The address entry screen or user interface may also receive other information regarding the real property or real estate transaction in addition to the mailing address.

Stages 404 and 406 may then be performed concurrently, though they may alternatively be performed sequentially. At stage 404, a request for further data not included in the user interface at stage 402 is presented on a user interface, such as GUI 104c, to obtain further information regarding the real property or real estate transaction. This next data screen may be configured so that the time taken by the user to complete it may take approximately as much time as the concurrent, parallel search for a legal address recognized for the entered mailing address.

At stage 406, a search for a recognized legal address is performed while the subsequent data request at stage 404 is performed. The search may be initiated by transmission of the mailing address from the client device A 104a to a host service 102, which then accesses and searches one or more legal address databases, such as those of a government agency. Alternatively, the client device A 104a may directly access and search one or more legal address databases.

At stage 408, a determination is made whether there is a unique legal address recognized for the real property associated with the received mailing address. In a simple case, the mailing address correctly and completely matches a legal address stored in a legal address record or database. In this case, the flow proceeds to stage 410, in which the legal address is used with the further data for the real estate transaction obtained in stage 404 for insertion into documents for the real estate transaction. The insertion may be automatically performed. Thereafter, further interactive operations between the host service 102 and the client device A 104a may be performed.

Determining a unique legal address or legal description for the real property based on the mailing address, such as the discrepancy explained in relation to FIG. 1D, can be made using any of multiple database matching algorithms. For example, a matching algorithm may proceed by hierarchical matching based on importance of the parts (or fields) of the mailing address. For example, the city name (or zip code) included in the mailing address can first be used to reduce the entries of the legal address database 107 that need to be searched further. Thereafter, the street name can be used to further reduce the possible legal addresses for comparison. Then the street number of the mailing address can be compared to those of the remaining legal addresses to find a match, if any.

At each of these stages, if the part of the mailing address being used by the algorithm is determined to be similar to a respective part of one or more legal addresses (e.g., the street name in the mailing address differs in only a few characters from a street name in the legal address database, as may occur from mistyping), those legal addresses having that respective part may be maintained by the algorithm as potential matches to be presented to the user for consideration.

As an example of a further search option, if a subsidiary section of the street address, such as the modifier “East” for the street name, is either absent (or present) in the mailing address but present (or absent) in a street address in the legal address database, those legal addresses may be maintained as potential matches to the mailing address.

Additionally and/or alternatively, other database search algorithms may also be used, either in parallel or in sequence. The result of such search algorithms may be either: an exact match between the mailing address and a legal address (ideally), or a list of potential or likely legal addresses for the real property at the mailing address.

At stage 408, after applying one or more search algorithms based on the mailing address, it may be that a legal address directly matching the received mailing address cannot be found in the accessed database of legal addresses 107. As noted, this may occur for any of multiple reasons. Examples may be a misspelling of the street name, an omitted street name modifier (such as “East”), an incorrect label (such as “Street” instead of “Avenue”), an incorrect number entered in the mailing address (such as “102b” rather than intended “112b”), or another reason. Further, as in the situation illustrated in FIG. 1D, it may be that the mailing address is a correctly entered and valid mailing address the real property, but that the correct legal address for that real property uses (as in FIG. 1D) a different street name. When such a failure to unambiguously match the mailing address to a legal address occurs, various alternative cases may occur.

In a first alternative case at stage 408, it may be that the received mailing address associated to the real property is different from the legal address for that real property, but the mailing address or previously entered information from the user also includes information that allows for matching the received mailing address to the real property, and matching the real property with the recognized legal address thereof. As one example of how this may occur, previously obtained information regarding the real property is used, such as GPS coordinates of real property. In a second example, the host service 102 may access a database that cross lists mailing addresses with plot numbers, and then the host service 102 accesses another database that correlates plot numbers with legal addresses. In these cases, the recognized legal address may be returned from the host service 102, such as to a calling program operating on the client device A 104a. Program flow of method 400 then proceeds to stage 410, as described above, in which the legal address is used in documents for the real estate transaction.

In a second alternative case at stage 408, it may be that the received mailing address cannot be uniquely matched or correlated with a known legal address for the real property. In this case, at stage 408, the method 400 may be unable to find a legal address that is unambiguously recognized for the mailing address. Flow of method 400 then proceeds to stage 412.

At stage 412, the method 400 may determine that it is necessary to present a warning or error message to the user stating that no legal address can be unambiguously recognized for the mailing address, and requesting a check or reentry of the mailing address. Other possible operations at stage 412 will now be explained.

FIG. 4B is a flow chart of a method 420 for resolving a legal address corresponding to a mailing address associated to a real property. This method 420 may be used as part of stage 412 of the method 400 disclosed in FIG. 4A. The method may be performed by either or both of the client device A 104a or the host service 102.

At stage 422, it has been determined that an entered mailing address cannot unambiguously be matched with a recognized legal address for a real property. This may occur for any of the reasons listed above, or for other reasons.

At stage 424, the method 420 may use a matching algorithm or program, such as any of the matching algorithms discussed previously, to obtain one or more recognized legal addresses from the legal address record that are likely or possible options for the real property of interest to the user. Such a program may rank the list of possible options for the legal address by a degree of differences from the received mailing address, by differences within the hierarchy of fields of the mailing address, or by other criteria.

As an example of such a ranking procedure, if two legal addresses match the street name of the received mailing address but neither matches the street number of the mailing address, but one such legal address is located in a different city, the legal address located in the same city may be ranked higher in a list to present to the user. However, this ranking choice may be modified if the street name is known to be to close a boundary between two nearby cities. As an example of such a scenario, a town name recognized for mailing purposes may actually refer to a part of a legally recognized city of a different name. As yet another example, a mailing address may have a city name that is a census-designated place name but that is actually an unincorporated section near an incorporated city, such as sections of Highlands Ranch, Colo., being an accepted alternative within the incorporated Littleton, Colo.

Having obtained a list of possible legal addresses, whether ranked or not, for the mailing address, the host service 102 may initially provide a map and/or satellite image for display on the client device 104 that has indicators showing the geographical location of each of the possible legal addresses. From such a display a party or an agent may quickly select the correct legal address.

At stage 426, from the list of the possible options for legal addresses and/or legal descriptions corresponding to the received mailing address, whether ranked or not, the method 420 may obtain ownership information for each of those options. The ownership information may include the name of the legal owner of the respective real property, or other owner identifying information. The method 420 may also obtain other information, in some cases by searching other databases, that may aid a user in resolving the discrepancy between the received mailing address and the possible legal addresses. The ownership information may be stored in the legal address record or in another database or source. The list of possible options for the legal address and the corresponding ownership information is then returned to the calling program (such as the software run by client device 104) for presentation to the user. Further contextual information may also be provided within the list, such as a Parcel ID number, legal description, or other plot identifier. The Parcel ID or plot identifier may be obtained by the host service 102 by accessing a database of property tax records maintained by a local taxing authority. Other tax records corresponding to the possible legal addresses may also be obtained and presented for resolving the discrepancy.

At stage 428a, the method 420 presents a query to the user for resolution of the discrepancy between the received mailing address and the possible legal addresses. This may be on a GUI presented on the client device 104. The query may be in the form of a selection operation for the user to perform to choose the correct legal address from the list of possible legal addresses. The selection operation may include a response equivalent to “none of the above” in order for the method to prompt for a reentry of a mailing address or perform other actions to resolve the problem. It is often the case that the respective ownership information corresponding to each of the possible legal addresses can allow for quickly selecting the correct legal address recognized for the real property associated to the entered mailing address.

The query to the user may include additional and/or alternative contextual information regarding the real properties corresponding to the entries in the list of possible legal addresses. In some embodiments, the query may present a link to an overlay map or satellite image showing the geographical location of each legal address in the list. Such a map may also have zoom features to allow a user (e.g., a party or an agent) to narrow the list quickly and visually. The query may additionally and/or alternatively provide street views of the properties for some or all of the legal addresses in the list. Such views may be obtained by accessing a third party database; e.g., Google Earth, Google Maps, MapQuest, or another geographical mapping and image provider.

At optional stage 428b, which may occur when the party or agent cannot resolve the discrepancy from the provided list of possible legal addresses, the host service 102 may store the received mailing address and/or the list of possible legal addresses. The host service 102 may then provide a customer service specialist for direct contact, such as by chat, phone call, or email, to provide assistance in resolving the discrepancy and help determine the needed legal address or other information.

FIG. 4C illustrates a graphical user interface (GUI) 430 to present possible or likely legal addresses to a user of the client device 104. The possible legal addresses may have been determined at stage 426 of the method of FIG. 4B. Such a GUI 430 may be used at stage 428a of the method 420 of FIG. 4B.

A first possible legal address 432 and second possible legal address 434 are displayed in the GUI 430. The GUI 430 may include a check box for each possible legal address. By displaying the possible legal addresses along with ownership or other information, a selection can be entered, such as by an agent or party, that can resolve the mismatch or discrepancy between the mailing address and the legal address for the real property. As stated previously, the agent or party will very likely know the owner of the real property of the real estate transaction or recognize invalid options, so the agent or party can use the GUI 430 to enter the selection of the correct legal address for the real property. Using the example presented in FIG. 1D, the agent or party can select possible legal address 432 as the correct legal address recognized for the condominium 112b. The selected legal address 432 can then be combined with other information to prepare documents and for other actions that are part of the real estate transaction. This may occur as in stage 410 of method 400.

In FIG. 4C, each of presented possible legal addresses 432 and 434 may contain other information that may be useful for making the selection of the correct legal address. In the example shown, each legal address 432 and 434 includes a Parcel Number, such as may be recognized by a local taxing authority. The host service 102 may have obtained such Parcel Number information from the same database from which it obtained the possible legal addresses, or by correlating the possible legal addresses with another database containing the Parcel Numbers. Each presented legal address may also contain a link (such as a hyperlink) to access a map showing the location of that legal address or to a map showing locations of some or all the identified possible legal addresses. The link, or an additional hyperlink, may be to a street view of the legal address. Still other information may be provided within each presented possible legal address.

As used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An electronic device, comprising:
a processing unit;
a user interface; and
a non-transitory memory containing instructions which, when implemented by the processing unit, cause the processing unit to:
receive, from the user interface, a mailing address associated with a real property;
access a legal address database;
compare the mailing address with the legal address database while concurrently causing the user interface to request further information related to a real estate transaction regarding the real property;
in the case that the legal address database contains a legal address recognized as corresponding to the real property associated with the mailing address, obtain the legal address corresponding to the real property from the legal address database; and
use the obtained legal address in documents related to the real estate transaction.

2. The electronic device of claim 1, wherein the legal address database is separate from the electronic device and is accessed by the electronic device through an internet connection.

3. The electronic device of claim 1, wherein the instructions further cause the processing unit to:
access a mailing address database; and
present autofill suggestions on the user interface as the mailing address is being received.

4. The electronic device of claim 1, wherein the instructions further cause the processing unit to:
determine validity of the mailing address; and
in the case that the mailing address is determined to be invalid, cause the user interface to indicate that the mailing address is invalid and request reentry of an updated mailing address.

5. The electronic device of claim 4, wherein the mailing address is determined to be invalid based on a comparison of the mailing address to a mailing address database.

6. The electronic device of claim 1, wherein the instructions further cause the processing unit to:
receive the requested further information from the user interface; and
use the further information in the documents related to the real estate transaction.

7. The electronic device of claim 1, wherein, in the case that the legal address database does not contain the legal address recognized as corresponding to the real property associated with the mailing address, the instructions further cause the processing unit to:
present on the user interface one or more legal addresses and respective ownership data, the one or more legal addresses determined to have a likelihood of being the legal address recognized as corresponding to the real property associated with the mailing address.

8. The electronic device of claim 7, wherein the instructions further cause the processing unit to:
receive from the user interface a selection of one of the presented one or more legal addresses to use as the legal address recognized as corresponding to the real property associated with the mailing address.

9. A method, comprising:
receiving, from a user interface, a mailing address associated with a real property;
comparing the received mailing address with a legal address record while concurrently causing the user interface to request further information related to a real estate transaction regarding the real property; and
obtaining a legal address recognized as corresponding to the real property associated with the received mailing address from the legal address record.

10. The method of claim 9, further comprising determining validity of the received mailing address.

11. The method of claim 10, further comprising, in the case that the received mailing address is determined to be invalid, causing the user interface to indicate that the received mailing address is invalid and request reentry of an updated mailing address.

12. The method of claim 9, wherein the user interface comprises a display screen operable to display a graphical user interface.

13. The method of claim 12, wherein the received mailing address is received using the graphical user interface.

14. The method of claim 13, wherein the graphical user interface presents autofill suggestions during the receiving of the mailing address.

15. The method of claim 9, further comprising:
receiving the further information from the user interface; and
using the further information with the legal address in documents for the real estate transaction.

16. The method of claim 9, further comprising, in the case that the legal address record has no legal address recognized as corresponding to the real property associated with the received mailing address, causing the user interface to indicate that there is no legal address associated with the received mailing address.

17. The method of claim 16, further comprising causing the user interface to present one or more legal addresses and respective ownership data, the one or more legal addresses determined to have a likelihood of being the legal address recognized as corresponding to the real property associated with the received mailing address.

18. The method of claim 9, wherein obtaining the legal address recognized as corresponding to the real property associated with the received mailing address comprises accessing the legal address record using an internet connection.
